(19) United States
(12) Patent Application Publication
(10) Pub. No.: US 2026/0302076 A1
(43) Pub. Date: Oct. 1, 2026

(54) MULTILAYER CERAMIC ELECTRONIC COMPONENT

(71) Applicant: Murata Manufacturing Co., Ltd., Nagaokakyo-shi (JP)

(72) Inventors: Kota ZENZAI, Nagaokakyo-shi (JP); Tatsunori YASUDA, Nagaokakyo-shi (JP)

(21) Appl. No.: 19/536,518

(22) Filed: Feb. 11, 2026

(30) Foreign Application Priority Data
Mar. 25, 2025 (JP) 2025-050626

(51) Int. Cl. H01G 4/30

(52) U.S. Cl. CPC H01G 4/30

(57) ABSTRACT

A multilayer ceramic capacitor includes a capacitor body including a multilayer body including a main surface and a pair of outer electrodes separated from each other in a length direction, a pair of spacers each connected to a respective one of the pair of outer electrodes, and an insulating resin layer on the main surface. Each of the pair of spacers includes a spacer first end surface on a side where the pair of spacers are opposed to each other in the length direction. The insulating resin layer is connected to the main surface of the multilayer body and the spacer first end surface of the spacer. The spacer first end surface includes an inclined surface that is inclined with respect to a lamination direction in which the capacitor body and the spacer are arranged. The insulating resin layer is connected to the inclined surface.

### CROSS REFERENCE TO RELATED APPLICATIONS

This application claims the benefit of priority to Japanese Patent Application No. 2025-050626 filed on Mar. 25, 2025. The entire contents of this application are hereby incorporated herein by reference.

### BACKGROUND OF THE INVENTION

### 1. Field of the Invention

The present invention relates to multilayer ceramic electronic components.

### 2. Description of the Related Art

In recent years, a multilayer ceramic capacitor having a high capacitance and a small size has been desired. Such a multilayer ceramic capacitor includes an inner layer portion in which dielectric layers including a ferroelectric material having a comparatively high dielectric constant and inner electrodes are alternately laminated.

Further, dielectric layers as outer layer portions are provided on the upper and lower sides of the inner layer portion to form a multilayer body having a rectangular parallelepiped shape, and outer electrodes are provided on both end surfaces of the multilayer body in a longitudinal direction, thus forming a capacitor body.

Moreover, there is known a multilayer ceramic capacitor including a spacer disposed on a side of mounting on a substrate in the capacitor body for suppressing the occurrence of so-called “acoustic noise” (refer to International Publication No. WO/2015/098990).

### SUMMARY OF THE INVENTION

However, when an adhesion force between the capacitor body and the spacer is weak, the spacer is sometimes peeled off, and thus durability when the multilayer ceramic capacitor is mounted has not been sufficient.

Example embodiments of the present invention provide multilayer ceramic electronic components that each achieve a high adhesion force between a capacitor body and a spacer and is excellent in durability when mounted.

A multilayer ceramic electronic component according to an example embodiment of the present invention includes a capacitor body including a multilayer body including a main surface and a pair of outer electrodes separated from each other in a first direction, a pair of spacers each connected to a respective one of the pair of outer electrodes, and a coating material on the main surface, wherein each of the pair of spacers includes an inner surface on a side where the pair of spacers are opposed to each other in the first direction, the coating material is connected to the main surface of the multilayer body and the inner surface of the spacer, the inner surface includes an inclined surface that is inclined with respect to a height direction in which the capacitor body and the spacer are arranged, and the coating material is connected to the inclined surface.

A multilayer ceramic electronic component according to another example embodiment of the present invention includes a capacitor body including a multilayer body including a main surface and a pair of outer electrodes separated from each other in a first direction, a pair of spacers each connected to a respective one of the pair of outer electrodes, and a coating material on the main surface, wherein each of the pair of spacers includes an inner surface on a side where the pair of spacers are opposed to each other, the coating material is connected to the main surface of the multilayer body and the inner surface, the inner surface includes a curved concave portion, and the coating material is connected to the curved concave portion.

According to example embodiments of the present invention, it is possible to provide multilayer ceramic electronic components that each achieve a high adhesion force between the capacitor body and the spacer and is excellent in durability when mounted.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to a first example embodiment of the present invention.

FIG. 2 is a partial cross-sectional view of the multilayer ceramic capacitor taken along line II-II in FIG. 1.

FIG. 3 is a cross-sectional view of the multilayer ceramic capacitor taken along line III-III in FIG. 1.

FIG. 4 is a partially enlarged view of FIG. 2 and is a cross-sectional view depicting a connection state of a spacer and an insulating resin layer.

FIG. 5 is a flowchart for explaining a manufacturing method for the multilayer ceramic capacitor.

FIGS. 6A to 6D are diagrams for explaining a multilayer body manufacturing step and an outer electrode forming step.

FIGS. 7A to 7C are diagrams for explaining a spacer disposing step and an insulating resin layer forming step.

FIG. 8 is a cross-sectional view depicting a connection state of a spacer and an insulating resin layer in a second example embodiment of the present invention.

FIG. 9 is a cross-sectional view depicting a connection state of a spacer and an insulating resin layer in a third example embodiment of the present invention.

FIG. 10 is a cross-sectional view depicting a connection state of a spacer and an insulating resin layer in a fourth example embodiment of the present invention.

FIG. 11 is a cross-sectional view depicting a connection state of a spacer and an insulating resin layer in a fifth example embodiment of the present invention.

FIG. 12 is a cross-sectional view depicting a connection state of a spacer and an insulating resin layer in a sixth example embodiment of the present invention.

FIG. 13 is a cross-sectional view depicting a connection state of a spacer and an insulating resin layer in a seventh example embodiment of the present invention.

FIG. 14 is a cross-sectional view depicting a connection state of a spacer and an insulating resin layer in an eighth example embodiment of the present invention.

FIG. 15 is a schematic transverse cross-sectional view of a spacer in a ninth example embodiment of the present invention.

FIG. 16 is a schematic transverse cross-sectional view of a spacer in a tenth example embodiment of the present invention.

FIG. 17 is a schematic transverse cross-sectional view of a spacer in an eleventh example embodiment of the present invention.

FIG. 18 is a schematic transverse cross-sectional view of a spacer in a twelfth example embodiment of the present invention.

FIG. 19 is a cross-sectional view depicting a connection state of a spacer and an insulating resin layer in a modification of the first example embodiment of the present invention.

### DETAILED DESCRIPTION OF THE EXAMPLE EMBODIMENTS

Example embodiments of multilayer ceramic capacitors as examples of the multilayer ceramic electronic components of the present invention are described. However, the present invention is not limited thereto. Further, in some cases, the drawings are schematically depicted in a simplified manner for describing the content of example embodiments of the present invention, and the ratio of dimensions in a depicted component or between depicted components does not coincide with the ratio of these dimensions described in the specification. In addition, there may be a case in which a component described in the specification is omitted in the drawing, a case in which a component described in the specification is depicted with a reduced number of components for simplification, and the like.

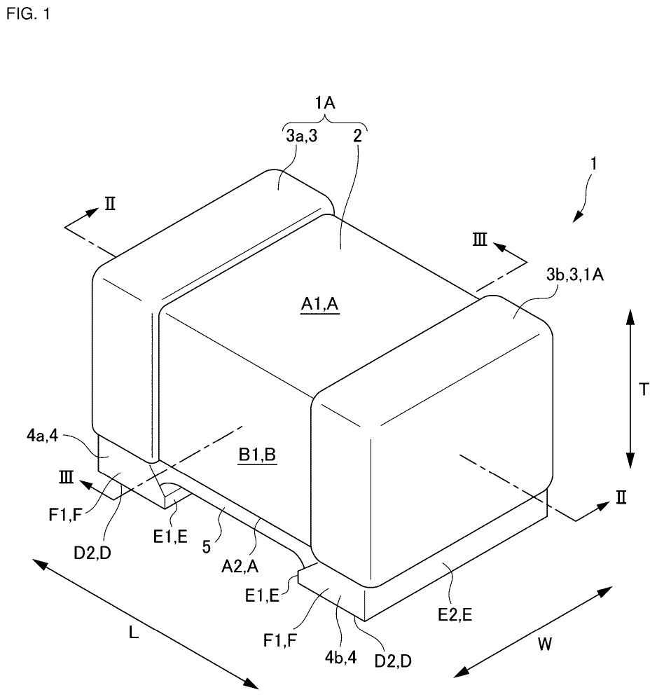

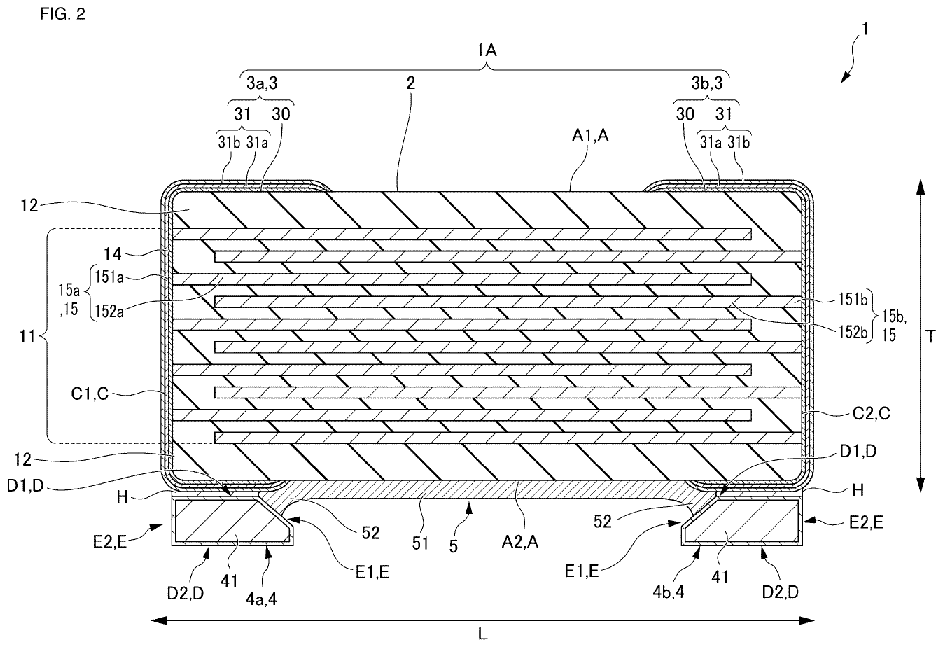

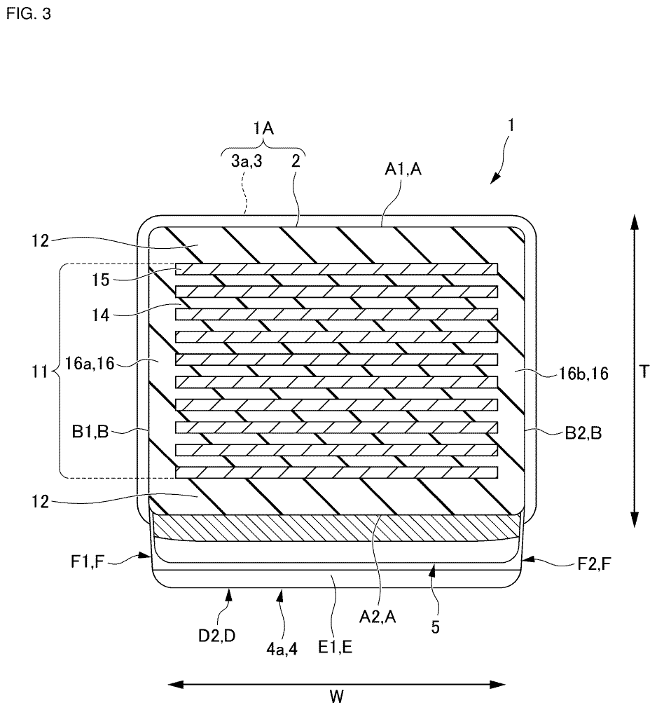

A first example embodiment of the present invention is described below. FIG. 1 is a schematic perspective view of the multilayer ceramic capacitor 1 according to the first example embodiment. FIG. 2 is a partial cross-sectional view of the multilayer ceramic capacitor 1 taken along line II-II in FIG. 1. FIG. 3 is a cross-sectional view of the multilayer ceramic capacitor 1 taken along line III-III in FIG. 1. Line II-II passes through the center of the multilayer ceramic capacitor 1 in a width direction W to be described later, and line III-III passes through the center in a length direction L to be described later.

The multilayer ceramic capacitor 1 includes a capacitor body 1A that has a substantially rectangular parallelepiped shape and includes a multilayer body 2 and a pair of outer electrodes 3 at both ends of the multilayer body 2, spacers 4 attached to the capacitor body 1A, and an insulating resin layer 5 (coating material). Further, the multilayer body 2 includes an inner layer portion 11 including a plurality of sets of dielectric layers 14 and inner electrode layers 15.

In the following description, as a term representing an orientation of the multilayer ceramic capacitor 1, a direction in which the pair of outer electrodes 3 are opposed to each other is defined as the length direction L (first direction). A direction in which the dielectric layers 14 and the inner electrode layers 15 are laminated is defined as a lamination direction T (height direction). A direction intersecting both the length direction L and the lamination direction T is defined as the width direction W (second direction). In the present example embodiment, the width direction W is orthogonal to both the length direction L and the lamination direction T.

Among six outer surfaces of the multilayer body 2, a pair of outer surfaces facing each other in the lamination direction T are defined as a multilayer body first main surface A1 and a multilayer body second main surface A2. Further, a pair of outer surfaces facing each other in the width direction W are defined as a multilayer body first side surface B1 and a multilayer body second side surface B2. In addition, a pair of outer surfaces facing each other in the length direction L are defined as a multilayer body first end surface C1 and a multilayer body second end surface C2.

When it is not required to particularly distinguish between the multilayer body first main surface A1 and the multilayer body second main surface A2, they are collectively referred to as multilayer body main surfaces A. When it is not required to particularly distinguish between the multilayer body first side surface B1 and the multilayer body second side surface B2, they are collectively referred to as multilayer body side surfaces B. When it is not required to particularly distinguish between the multilayer body first end surface C1 and the multilayer body second end surface C2, they are collectively referred to as multilayer body end surfaces C.

The spacers 4 are a pair of structures (described later). Among six outer surfaces of the spacer 4, of a pair of outer surfaces facing each other in the lamination direction T, an outer surface on the capacitor body 1A side is defined as a spacer first main surface D1 (first main surface), and an outer surface on the opposite side thereof is defined as a spacer second main surface D2 (second main surface). The spacer first main surface D1 is a surface on the multilayer body 2 side, and the spacer second main surface D2 is a surface on the mounting substrate (not depicted) side.

Of a pair of outer surfaces of the spacer 4 facing each other in the length direction L, a surface on the side where the two spacers 4 are opposed to each other is defined as a spacer first end surface E1 (inner surface), and an outer surface on the opposite side thereof is defined as a spacer second end surface E2.

Of a pair of outer surfaces of the spacer 4 facing each other in the width direction W, a surface on a single side in the width direction W is defined as a spacer first side surface F1 (first side surface), and a surface on the opposite side is defined as a spacer second side surface F2 (second side surface).

When it is not required to particularly distinguish between the spacer first main surface D1 and the spacer second main surface D2, they are collectively referred to as spacer main surfaces D. When it is not required to particularly distinguish between the spacer first end surface E1 and the spacer second end surface E2, they are collectively referred to as spacer end surfaces E. When it is not required to particularly distinguish between the spacer first side surface F1 and the spacer second side surface F2, they are collectively referred to as spacer side surfaces F.

The dimensions of the multilayer body 2 are not particularly limited. However, it is preferable that the dimensions be as follows: a dimension in the length direction L is about 1.0 mm or more and about 3.2 mm or less, a dimension in the width direction W is about 0.5 mm or more and about 1.6 mm or less, and a dimension in the lamination direction T is about 0.5 mm or more and about 1.6 mm or less, for example.

The multilayer body 2 includes the inner layer portion 11, outer layer portions 12 on both sides of the inner layer portion 11 in the lamination direction T, and side gap portions 16 on both sides of the inner layer portion 11 and the outer layer portions 12 in the width direction W.

The inner layer portion 11 includes the plurality of sets of the dielectric layers 14 and the inner electrode layers 15 alternately laminated along the lamination direction T.

It is preferable that the thickness of the dielectric layer 14 be about 0.5 μm or less, for example. The dielectric layer 14 is made of a ceramic material. As the ceramic material, for example, a dielectric ceramic including BaTiO₃ as a main component is used. In addition, as the ceramic material, a material obtained by adding at least one of subcomponents such as a Mn compound, an Fe compound, a Cr compound, a Co compound, and a Ni compound to the main component may be used. It is preferable that the number of dielectric layers 14, including those of the outer layer portions 12, be 15 or more and 700 or less, for example.

Further, the inner electrode layers 15 include a plurality of first inner electrode layers 15a and a plurality of second inner electrode layers 15b. The first inner electrode layers 15a and the second inner electrode layers 15b are alternately arranged. When it is not required to particularly distinguish between the first inner electrode layers 15a and the second inner electrode layers 15b, they are collectively referred to as the inner electrode layers 15.

The first inner electrode layers 15a each include a first opposing portion 152a opposed to the second inner electrode layer 15b and a first extended portion 151a extended from the first opposing portion 152a toward the multilayer body first end surface C1 side. End portions of the first extended portions 151a are exposed at the multilayer body first end surface C1, and are electrically connected to a first outer electrode 3a to be described later.

The second inner electrode layers 15b each include a second opposing portion 152b opposed to the first inner electrode layer 15a and a second extended portion 151b extended from the second opposing portion 152b to the multilayer body second end surface C2. End portions of the second extended portions 151b are electrically connected to a second outer electrode 3b to be described later.

A charge is accumulated in the first opposing portions 152a of the first inner electrode layers 15a and the second opposing portions 152b of the second inner electrode layers 15b, and characteristics of the capacitor are exhibited.

As described above, the end portions of the first extended portions 151a of the first inner electrode layers 15a are exposed at the multilayer body first end surface C1, and are electrically connected to the first outer electrode 3a. Further, the end portions of the second extended portions 151b of the second inner electrode layers 15b are exposed at the multilayer body second end surface C2, and are electrically connected to the second outer electrode 3b. This provides a structure in which a plurality of capacitor elements are electrically connected in parallel between the first outer electrode 3a and the second outer electrode 3b.

It is preferable that the inner electrode layer 15 include a metal material typified by, for example, Ni, Cu, Ag, Pd, an Ag-Pd alloy, Au, or the like. It is preferable that the thickness of the inner electrode layer 15 be, for example, about 0.5 μm or more and about 2.0 mm or less. It is preferable that the total number of the inner electrode layers 15, including the first inner electrode layers 15a and the second inner electrode layers 15b, be 15 or more and 700 or less, for example. Further, a Sn layer may be present at an interface between the inner electrode layer 15 and the dielectric layer 14.

The shape of the first opposing portion 152a of the first inner electrode layer 15a and the shape of the second opposing portion 152b of the second inner electrode layer 15b are not particularly limited, but are preferably rectangular or substantially rectangular in plan view. However, a corner portion may be rounded in plan view, or the corner portion may be formed to be oblique in plan view. Further, the shape may be a tapered shape in which an inclination is given in a direction toward either end portion in plan view.

The shape of the first extended portion 151a of the first inner electrode layer 15a and the shape of the second extended portion 151b of the second inner electrode layer 15b are not particularly limited, but are preferably rectangular or substantially rectangular in plan view. However, a corner portion may be rounded in plan view, or the corner portion may be formed to be oblique in plan view (tapered shape). Further, the shape may be a tapered shape in which an inclination is given in a direction toward either end portion in plan view.

It is preferable that the outer layer portion 12 be made of the same material as that of the dielectric layer 14 of the inner layer portion 11, but the material is not particularly limited. The amount of an additive may be different between the inner layer portion 11 and the outer layer portion 12. Further, the thickness of the outer layer portion 12 in the lamination direction T is, for example, about 20 μm or less, and is preferably about 10 μm or less.

The side gap portions 16 are provided on both sides of the inner layer portion 11 and the outer layer portions 12 in the width direction W, and include a first side gap portion 16a forming the multilayer body first side surface B1 of the multilayer ceramic capacitor 1 and a second side gap portion 16b of the multilayer body second side surface B2 of the multilayer ceramic capacitor 1. The side gap portion 16 can include the same material as that of the dielectric layer 14. When the side gap portions 16 are additionally provided on both sides of the inner layer portion 11 and the outer layer portions 12 in the width direction W, it is possible to reduce the amount of positional deviation of the end portions of the inner electrode layers 15 in the width direction W. The amount of positional deviation of the end portions of the inner electrode layers 15 in the width direction W is preferably about 5 μm or less, and more preferably about 0.5 μm or less, for example. The amount of an additive may be different between the inner layer portion 11 and the side gap portion 16. The amount of an additive may be different between the outer layer portion 12 and the side gap portion 16.

The outer electrodes 3 are provided on the multilayer body end surfaces C on both sides of the multilayer body 2. The outer electrodes 3 cover not only the multilayer body end surfaces C but also portions of the multilayer body main surfaces A and the multilayer body side surfaces B on the multilayer body end surface C side. As described above, the end portions of the extended portions 151 of the inner electrode layers 15 are exposed at the multilayer body end surfaces C, and are electrically connected to the outer electrodes 3. Specifically, the outer electrodes 3 include the first outer electrode 3a disposed on the multilayer body first end surface C1 and the second outer electrode 3b on the multilayer body second end surface C2. When it is not required to particularly distinguish between the first outer electrode 3a and the second outer electrode 3b, they are collectively referred to as the outer electrodes 3.

The outer electrodes 3 each include an underlying electrode layer 30 and a plated layer 31.

The underlying electrode layer 30 is formed, for example, by applying and baking a conductive paste including copper (Cu). The underlying electrode layer 30 may include a glass component or a ceramic material. As depicted in FIG. 2, the underlying electrode layers 30 extend not only on the multilayer body end surfaces C on both sides of the multilayer body 2 but also to the multilayer body main surface A side to cover also portions of the multilayer body main surfaces A on the multilayer body end surface C side.

The plated layer 31 includes a Ni plated layer 31a on a surface of the underlying electrode layer 30 and a Sn plated layer 31b on a surface of the Ni plated layer 31a. The Ni plated layer 31a includes a plating of Ni or an alloy including Ni. Similarly to the underlying electrode layers 30, the Ni plated layers 31a extend not only on the multilayer body end surfaces C on both sides of the multilayer body 2 but also to the multilayer body main surface A side to cover also portions of the multilayer body main surfaces A on the multilayer body end surface C side. The Sn plated layer 31b is formed on the surface of the Ni plated layer 31a. The Sn plated layer 31b includes a plating of Sn or an alloy including Sn. Although the Ni plated layer 31a and the Sn plated layer 31b have been given as examples of the plated layer 31, the plated layer 31 is not limited thereto.

The spacers 4 are a pair of structures as described above, and, specifically, include a first spacer 4a and a second spacer 4b. Hereinafter, when it is not required to distinguish between the first spacer 4a and the second spacer 4b, they are referred to as the spacers 4.

The first spacer 4a is provided on the multilayer body first end surface C1 side on one side in the length direction L under the multilayer body second main surface A2 of the capacitor body 1A, and the second spacer 4b is provided on the multilayer body second end surface C2 side on the other side. The first spacer 4a and the second spacer 4b are opposed to each other, and are separated by a certain distance.

The spacers 4 are electrically connected to the outer electrodes 3 by solder H (conductive adhesive). Specifically, the spacer first main surfaces D1, which are upper surfaces of the spacers 4, are joined to the outer electrodes 3 with the solder H under the multilayer body second main surface A2, which is a lower surface of the capacitor body 1A. The solder H includes a metal having a melting point of about 210° C. or higher as a main component, for example. In the present example embodiment, the solder H is manufactured using, for example, high-temperature solder. The high-temperature solder is a metal that includes, for example, Sn, Ag, or Cu and has a remelting temperature of about 300° C. or higher, for example. After being once melted at about 200° C. or higher and then cooled and solidified, the high-temperature solder is not remelted unless heated to about 300° C. or higher, for example. The solder H is not limited thereto. For example, Sn-Sb-based high-temperature solder may be used. When the spacers 4 and the outer electrodes 3 are connected using the solder H, if Sn plated layers are used as the outermost surfaces of the outer electrodes 3 and the spacers 4, a portion of the Sn plated layers is absorbed into the solder H and a boundary therebetween becomes unclear in some cases. The conductive adhesive is not limited to the solder H, and a substance obtained by combining a thermosetting resin and metal powder may be used as the conductive adhesive.

The spacer 4 includes a core portion 41. The core portion 41 includes a metal block body including a metallic component as a main component or a substrate such as flame retardant type 4 (FR4). As an example, the core portion 41 includes at least one high-melting-point metal selected from Cu and Ni. That is, the melting point of the core portion 41 is higher than the melting point of solder (conductive adhesive) used in mounting and the melting point of the solder H (conductive adhesive) used in connecting the spacers 4 and the outer electrodes 3. When the core portion includes a substrate, it is preferable to use a porous substrate because stress can be buffered. When the core portion 41 includes a bulk body including a metal block body, a substrate, or the like, compared with a case in which the spacer 4 includes a metal paste including an organic component and a metallic component, the existence ratio of voids interposed inside can be reduced or be made zero, or sizes of the voids can be reduced. Thus, it is possible to reduce a possibility that the spacer 4 itself fractures.

The spacer first end surface E1 includes an inclined surface 46 that is inclined with respect to the lamination direction T. The insulating resin layer 5 is connected to the inclined surface 46 (described later).

Specifically, the inclined surface 46 of the spacer first end surface E1 is located on the spacer first main surface D1 side of the spacer first end surface E1. The inclined surface 46 has a shape obtained by cutting away an original corner portion between the spacer first end surface E1 and the spacer first main surface D1 of the core portion 41 as a rectangular or substantially rectangular parallelepiped, and secures a space on the spacer first main surface D1 side of the spacer first end surface E1. The spacer first end surface E1 on the spacer second main surface D2 side is a flat surface 49 parallel to the lamination direction T.

More specifically, a portion where the spacer second main surface D2 and the spacer first end surface E1 of the spacer 4 intersect is a first ridge portion 47. A portion where the spacer first main surface D1 and the spacer first end surface E1 intersect is a second ridge portion 48. The first ridge portion 47 is located on an inner side in the length direction L, that is, on a side closer to the other spacer, relative to the second ridge portion 48. Due to this structure, a material of the insulating resin layer 5 is less likely to spread upward.

Further, the first ridge portion 47 is located on the inner side in the length direction L, that is, on the side closer to the other spacer, relative to the outer electrode 3. Due to this structure, the material of the insulating resin layer 5 is less likely to excessively spread upward to the spacer second main surface D2.

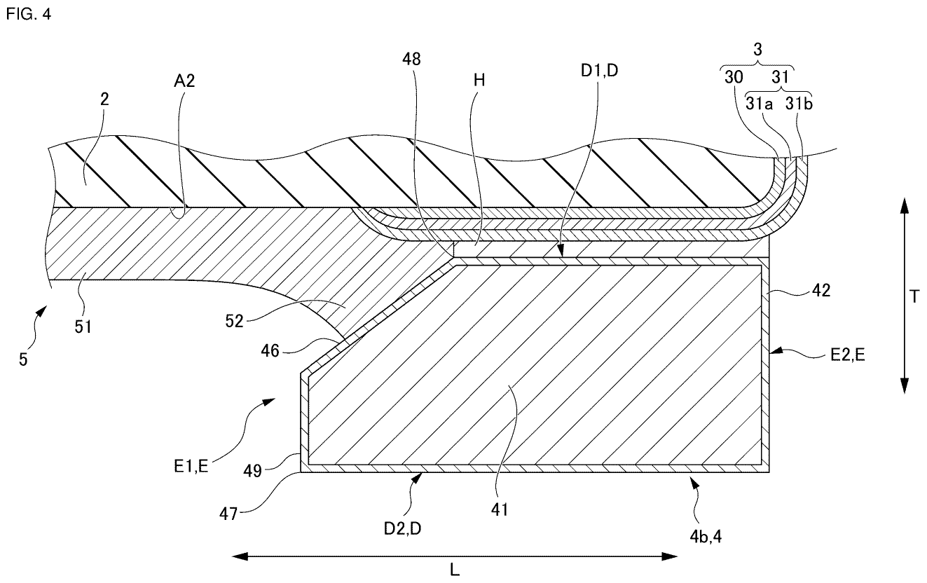

As depicted in FIG. 4, the spacer 4 includes a low-melting-point surface layer 42. The low-melting-point surface layer 42 includes, for example, Sn. It is preferable that the low-melting-point surface layer 42 have favorable wettability with the solder H (conductive adhesive) used in mounting and to connect the spacer 4 and the outer electrode 3. With the low-melting-point surface layer 42, favorable solderability is achieved at the spacer 4 when the multilayer ceramic capacitor 1 is mounted on a substrate.

The low-melting-point surface layer 42 entirely coats the core portion 41. Specifically, the low-melting-point surface layer 42 is provided on the spacer main surfaces D, the spacer side surfaces F, and the spacer end surfaces E of the core portion 41.

As depicted in FIG. 1, the insulating resin layer 5 is provided between the two spacers 4 so as to cover the multilayer body second main surface A2 side of the capacitor body 1A. The spacers 4 are physically connected to the multilayer body 2 by the insulating resin layer 5 (described later).

The insulating resin layer 5 includes an insulating resin. A surface of the insulating resin may be coated with a water-repellent treatment agent. Flexural strength is improved by forming the insulating resin layer 5 from the insulating resin. Further, moisture resistance is improved by coating the insulating resin with the water-repellent treatment agent. The insulating resin may include a ceramic, glass, or the like. The insulating resin layer 5 includes an epoxy resin as a main component, and a phenolic resin can be combined therewith as a curing agent. When a viscous material such as an epoxy resin is used, the multilayer body 2 and the spacers 4 can be connected more easily. As other curing agents, acid anhydride-based, amine-based, and ester-based curing agents, and the like, can be used. A curing accelerator may further be added to the epoxy resin. The insulating resin layer 5 may include only the water-repellent treatment agent.

As depicted in FIG. 2, the insulating resin layer 5 is provided continuously in the length direction L between the spacer first end surface E1 of one of the spacers 4 and the spacer first end surface E1 of the other spacer 4, and covers the multilayer body second main surface A2 side of the capacitor body 1A (multilayer body 2) and the spacer first end surfaces E1 of the two spacers 4.

However, the insulating resin layer 5 is not necessarily required to be continuous between the first spacer 4a and the second spacer 4b. The insulating resin layer 5 may be discontinuously provided so as to be divided, for example, into a layer coating the spacer first end surface E1 of the first spacer 4a and a portion of the multilayer body second main surface A2 side of the capacitor body 1A (multilayer body 2) and a layer coating the spacer first end surface E1 of the second spacer 4b and a portion of the multilayer body second main surface A2 side of the capacitor body 1A (multilayer body 2).

A connection state of the spacer 4 and the insulating resin layer 5 is described with reference to FIG. 4. FIG. 4 is a partially enlarged view of FIG. 2 and is a cross-sectional view depicting the connection state of the spacer 4 and the insulating resin layer 5.

The insulating resin layer 5 is directly connected to the multilayer body second main surface A2 of the multilayer body 2 and the inclined surface 46 of the spacer 4. The insulating resin layer 5 is also connected to the solder H (conductive adhesive). Specifically, the insulating resin layer 5 includes a main layer 51 on the multilayer body second main surface A2 and connection portions 52 at both ends of the main layer 51, and the connection portions 52 are each connected to the inclined surface 46 and the solder H (conductive adhesive). The connection portions 52 are upward-spread portions extending from the main layer 51.

In the present example embodiment, in the core portion 41, a bulk body including a metal block body, a substrate, or the like and a thin film on a surface of the bulk body by, for example, plating or the like are provided. When the roughness of the surface of the core portion 41 becomes small, there is a possibility that the material of the insulating resin layer 5 excessively spreads upward to the spacer second main surface D2 and a dimensional difference from the first spacer 4a and the second spacer 4b in the lamination direction T increases and mounting becomes unstable. Further, there is a possibility that the material of the insulating resin layer 5 excessively extends around to the spacer second end surface E2 and thus the solder H (conductive adhesive) used in mounting does not sufficiently adhere to the spacer 4.

As described above, in the present example embodiment, the connection portion 52 of the insulating resin layer 5 is connected to the inclined surface 46. That is, the material of the insulating resin layer 5 can be accommodated in a space defined by the inclined surface 46, thus making it possible to prevent or reduce excessive upward spreading of the material of the insulating resin layer 5. Further, the inclined surface 46 can increase the adhesion area between the insulating resin layer 5 and the spacer 4.

The surface roughness of the core portion located on the inclined surface 46 is rougher than the surface roughness of the other portion of the core portion 41. As a result, due to an anchor effect, the adhesion strength between the insulating resin layer 5 and the spacer 4 can be increased. Roughening treatment for the inclined surface 46 may be performed by chemical etching or the like, or by applying a physical impact. The above limitation on the surface roughness is also common to the following other example embodiments.

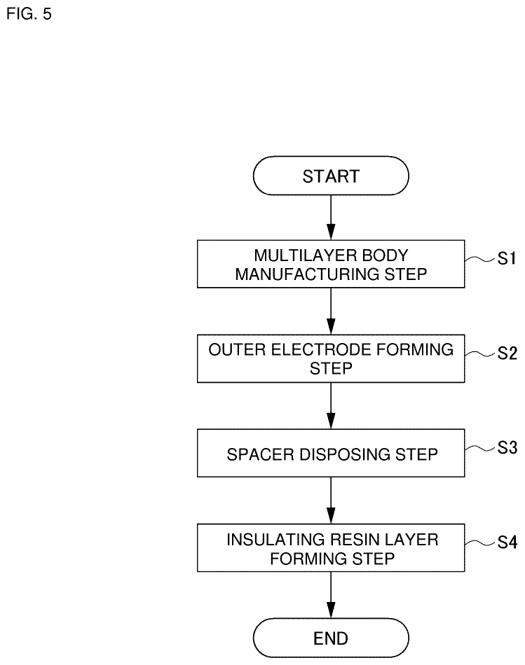

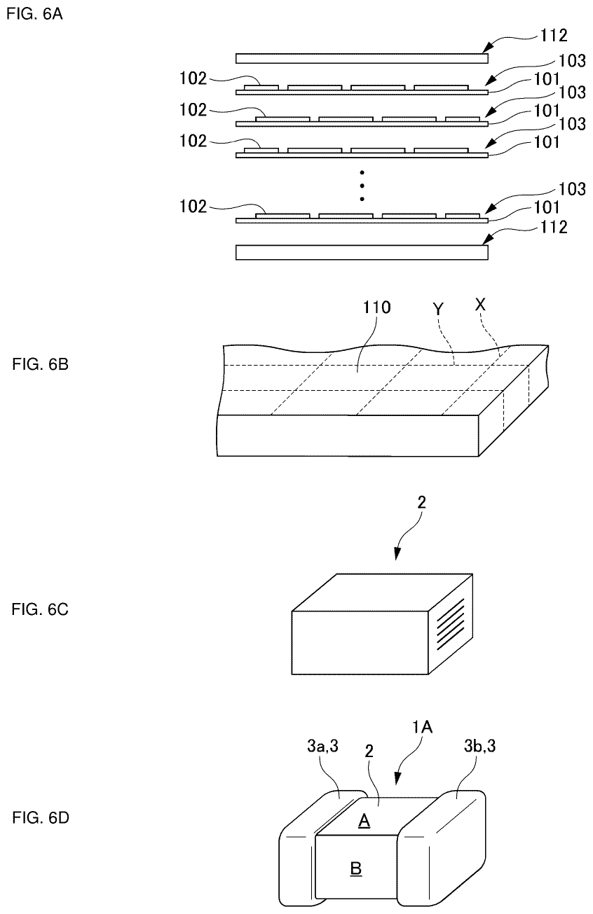

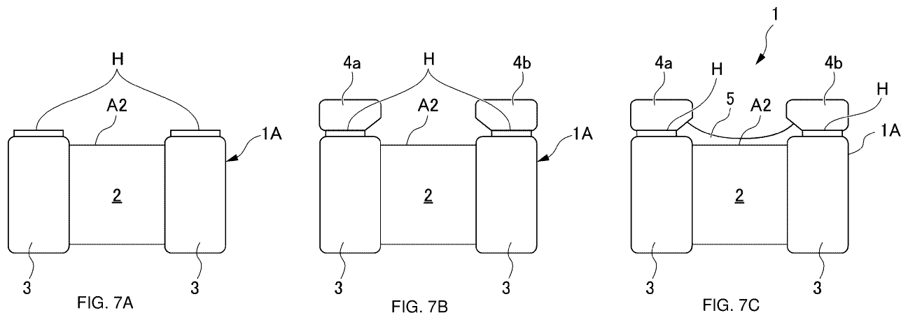

A non-limiting example of a manufacturing method for the multilayer ceramic capacitor 1 is described with reference to FIGS. 5 to 7. FIG. 5 is a flowchart for explaining the manufacturing method for the multilayer ceramic capacitor. FIG. 6 is a diagram for explaining a multilayer body manufacturing step and an outer electrode forming step. FIG. 7 is a diagram for explaining a spacer disposing step and an insulating resin layer forming step.

As depicted in FIG. 5, the manufacturing method for the multilayer ceramic capacitor 1 includes a multilayer body manufacturing step S1, an outer electrode forming step S2, a spacer disposing step S3, and an insulating resin layer forming step S4.

Ceramic slurry including ceramic powder, a binder, and a solvent is formed in a sheet shape on a surface of a carrier film using a die coater, a gravure coater, a micro-gravure coater, or the like to fabricate a ceramic green sheet 101 for lamination to serve as the dielectric layer 14. Next, a conductor paste is printed in a strip shape on the ceramic green sheet 101 for lamination by screen printing, ink-jet printing, gravure printing, or the like to print a conductive pattern 102 to serve as the inner electrode layer 15 on a surface of the ceramic green sheet 101 for lamination, thus fabricating a material sheet 103.

Subsequently, as depicted in FIG. 6A, a plurality of material sheets 103 are stacked such that the conductive patterns 102 are oriented in the same direction and, between adjacent material sheets 103, the conductive patterns 102 are offset from each other in the length direction L by, for example, a half pitch. Further, ceramic green sheets 112 for the outer layer portion to serve as the outer layer portions 12 are stacked on both sides of the plurality of stacked material sheets 103.

The stacked material sheets 103 and the ceramic green sheets 112 for the outer layer portion are pressure-bonded by isostatic pressing or the like to fabricate a mother block 110 depicted in FIG. 6B.

Next, the mother block 110 is cut along cutting lines X depicted in FIG. 6B and cutting lines Y intersecting the cutting lines X to manufacture a plurality of multilayer bodies 2 depicted in FIG. 6C.

Subsequently, the underlying electrode layers 30 are formed by applying a conductive paste including copper (Cu) to the multilayer body end surfaces C of the multilayer body 2 and baking the conductive paste. The underlying electrode layers 30 are formed so as to extend not only on the multilayer body end surfaces C on both sides of the multilayer body 2 but also to the multilayer body main surface A side and the multilayer body side surface B side of the multilayer body 2 to cover also portions of the multilayer body main surfaces A on the multilayer body end surface C side. Next, the Ni plated layers 31a and the Sn plated layers 31b on surfaces of the Ni plated layers 31a are formed as the plated layer 31 over surfaces of the underlying electrode layers 30, thus manufacturing the capacitor body 1A depicted in FIG. 6D.

When the core portion 41 is formed of a metal block body including a metal as a main component, a metal plate having a predetermined thickness is first prepared. Thereafter, the metal plate is diced into a plate having a predetermined size, and then a surface layer is formed on a surface of the metal plate. The dicing of the metal plate may be performed, for example, so as to form a plate having a dimension close to the dimension of one multilayer ceramic capacitor in the length direction L, or having a dimension close to the total dimension of two multilayer ceramic capacitors in the width direction W, or having a dimension close to the total dimension of two outer electrodes disposed in one multilayer ceramic capacitor in the length direction L. It is preferable that the surface layer be formed by plating. The surface layer may be formed before the above dicing, or may be formed after the above dicing. The surface layer may be including two or more layers. Finally, plating for forming the low-melting-point surface layer 42 is performed to form the low-melting-point surface layer 42.

When the core portion 41 includes a substrate such as FR4, a substrate having a predetermined thickness is first prepared. Thereafter, the substrate is diced into a substrate having a predetermined size, and then a surface layer is formed on a surface of the substrate. The dicing of the substrate may be performed, for example, so as to form a substrate having a dimension close to the dimension of one multilayer ceramic capacitor in the length direction L, or having a dimension close to the total dimension of two multilayer ceramic capacitors in the width direction W, or having a dimension close to the total dimension of two outer electrodes disposed in one multilayer ceramic capacitor in the length direction L. It is preferable that the surface layer be formed of, for example, a thin film of copper or the like and a plated layer. The surface layer may be formed before the above dicing, or may be formed after the above dicing. The surface layer may be including two or more layers. Finally, plating for forming the low-melting-point surface layer 42 is performed to form the low-melting-point surface layer 42.

At this time, the inclined surface 46 may be formed by, for example, machining. The method for forming the inclined surface 46 is not limited thereto. The inclined surface can be partially formed also by forming a concave surface or a convex surface in a plate having a predetermined thickness or by forming a plate having a concave portion or a convex portion and then cutting the concave site or the convex site.

First, as depicted in FIG. 7A, the solder H in a cream state is provided on the capacitor body 1A by screen printing or the like. Next, as depicted in FIG. 7B, the first spacer 4a and the second spacer 4b are placed over the capacitor body 1A. Specifically, the first spacer 4a and the second spacer 4b are joined to the first outer electrode 3a and the second outer electrode 3b, respectively, of the capacitor body 1A. As another example, the following process may be used. A plate resulting from dicing is diced into a plate having a dimension close to the dimension of one multilayer ceramic capacitor in the length direction L, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is provided on the first spacer 4a and the second spacer 4b by screen printing or the like, and then the capacitor body 1A is placed thereon. Thereafter, reflow is performed to join the first spacer 4a and the second spacer 4b to the capacitor body 1A.

Alternatively, as another example, the following process may be used. A plate resulting from dicing is diced into a plate having a dimension close to the total dimension of two multilayer ceramic capacitors in the width direction W, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is disposed on the first spacer 4a and the second spacer 4b by screen printing or the like, and then the capacitor body 1A is placed thereon. Thereafter, reflow is performed to join the first spacer 4a and the second spacer 4b to the capacitor body 1A. By joining the capacitor bodies 1A to the plate before forming the first spacer 4a and the second spacer 4b, and performing dicing between the capacitor bodies 1A arranged in the width direction W, the multilayer ceramic capacitors including the first spacer 4a and the second spacer 4b may be formed. In this case, the plate before forming the first spacer 4a and the second spacer 4b has a size larger than the total dimension of two multilayer ceramic capacitors in the width direction W. Further, the dimension of the first spacer 4a and the second spacer 4b in the width direction W may be larger than the dimension of the capacitor body 1A.

Alternatively, as another example, the following process may be used. A plate resulting from dicing is diced into a plate having a dimension close to the total dimension of two outer electrodes disposed in one multilayer ceramic capacitor in the length direction L, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is provided on the first spacer 4a and the second spacer 4b by screen printing or the like, and then the capacitor body 1A is placed thereon. Thereafter, reflow is performed to join the first spacer 4a and the second spacer 4b to the capacitor body 1A. By joining the capacitor bodies 1A to the plate before forming the first spacer 4a and the second spacer 4b, and performing dicing between the capacitor bodies 1A arranged in the length direction L, the multilayer ceramic capacitors including the first spacer 4a and the second spacer 4b may be formed. In this case, the plate before forming the first spacer 4a and the second spacer 4b has a size larger than the total dimension of two outer electrodes in one multilayer ceramic capacitor in the length direction L. Further, a portion of the first spacer 4a and the second spacer 4b may protrude from the capacitor body 1A when viewed in the lamination direction T.

Next, as depicted in FIG. 7C, a resin material layer that becomes the insulating resin layer 5 is on the multilayer body second main surface A2 portion of the capacitor body 1A by using a dispenser or squeegee printing. At this time, the amount of upward spreading to the spacer can be varied depending on the amount and viscosity of the insulating resin.

By putting the capacitor body 1A to which the resin material layer has been applied in an environment at, for example, about 180° C. for about 60 minutes, the resin material layer is thermally cured. Although a thermosetting resin is used as the resin material layer in the present example embodiment, the resin material layer is not limited thereto and a photocurable resin may be used.

As a result, the resin material layer becomes the insulating resin layer 5 cured, and finally, the multilayer ceramic capacitor 1 is obtained. Between the spacer disposing step S3 and the insulating resin layer forming step S4, an inclined surface roughening treatment step or a plating removal step may be provided.

As described above, according to the multilayer ceramic capacitor 1 of the present example embodiment, because the spacers 4 are attached to the capacitor body 1A, excessive upward spreading of solder used in mounting to the capacitor body 1A can be reduced or prevented by the spacers 4, and vibration transmitted to the mounting substrate can be reduced or prevented.

Further, according to the multilayer ceramic capacitor 1 of the present example embodiment, the insulating resin layer 5 is attached between the spacers 4. Accordingly, the adhesion force between the capacitor body 1A and the spacers 4 can be increased, and separation of the spacers 4 from the capacitor body 1A can be prevented or reduced. In addition, resistance to the occurrence of a crack or the like in the multilayer ceramic capacitor 1 when bending or the like occurs in the mounting substrate, that is, substrate bending resistance, is improved.

In the present example embodiment, the insulating resin layer 5 and the inclined surface 46 are directly connected. That is, the inclined surface 46 reduces the amount of movement of upward spreading of the insulating resin layer 5. That is, excessive upward spreading of the material of the insulating resin layer 5 attempting to move from the multilayer body second main surface A2 toward the spacer second main surface D2 of the spacer 4 can be blocked by the inclined surface 46. Thus, it is possible to prevent or reduce excessive presence of the insulating resin layer 5 on the spacer second main surface D2, and to reduce or prevent a decrease in mountability caused by an increase in a dimensional difference from the first spacer 4a and the second spacer 4b in the lamination direction T. In addition, the adhesion area between solder in mounting and the spacer 4 can be sufficiently secured. As a result, the multilayer ceramic capacitor 1 excellent in durability when mounted is achieved.

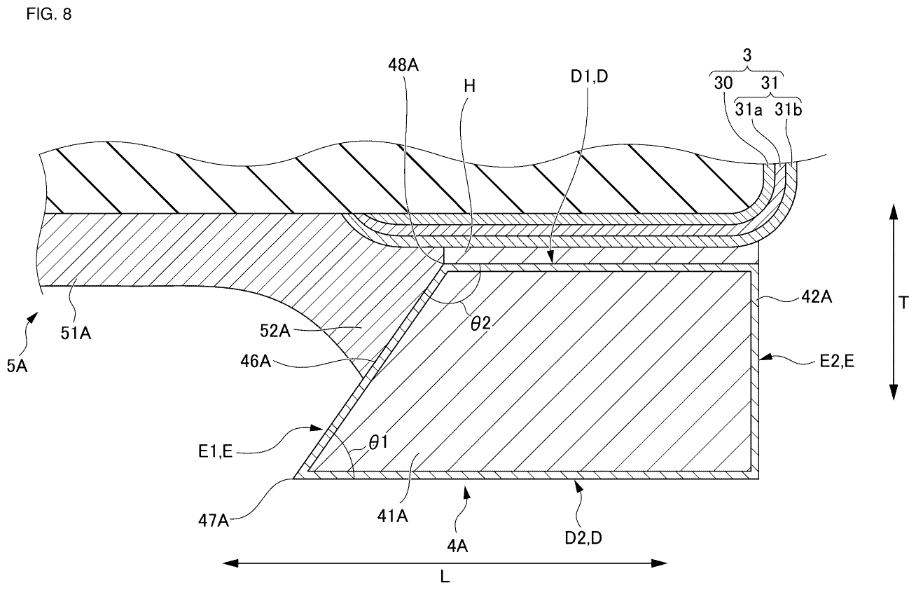

In the first example embodiment, the inclined surface 46 of the spacer 4 is partially provided in the spacer first end surface E1 on the spacer first main surface D1 side. However, the position of the inclined surface is not limited to the first example embodiment. With reference to FIG. 8, an example in which the position of the inclined surface is different is described as a second example embodiment. FIG. 8 is a cross-sectional view depicting a connection state of a spacer 4A and an insulating resin layer 5A in the second example embodiment. The basic configuration of the second example embodiment is the same as that of the first example embodiment. Thus, different points are mainly described below (the same applies to the following example embodiments).

The spacer first end surface E1 of the spacer 4A includes an inclined surface 46A inclined with respect to the lamination direction T. The insulating resin layer 5A is connected to the inclined surface 46A (described later).

Specifically, the inclined surface 46A of the spacer first end surface E1 has a shape obtained by cutting away an original end surface of a core portion 41A as a rectangular or substantially rectangular parallelepiped, and extends across the entire spacer first end surface E1.

More specifically, a portion where the spacer second main surface D2 and the spacer first end surface E1 of the spacer 4A intersect is a first ridge portion 47A. A portion where the spacer first main surface D1 and the spacer first end surface E1 intersect is a second ridge portion 48A. The first ridge portion 47A is located on an inner side in the length direction L, that is, on a side closer to the other spacer, relative to the second ridge portion 48A. Due to this structure, a material of the insulating resin layer 5A is less likely to excessively spread upward to the spacer second main surface D2.

Further, the first ridge portion 47A is located on the inner side in the length direction L, that is, on the side closer to the other spacer, relative to the outer electrode 3. Due to this structure, the material of the insulating resin layer 5A is less likely to excessively spread upward to the spacer second main surface D2.

The spacer second main surface D2 and the spacer first end surface E1 of the spacer 4A define a first angle θ1. Further, the spacer first main surface D1 and the spacer first end surface E1 define a second angle θ2. The first angle θ1 is an acute angle, and the second angle θ2 is an obtuse angle. That is, the first angle θ1 is smaller than the second angle θ2.

The insulating resin layer 5A is directly connected to the multilayer body second main surface A2 of the multilayer body 2 and the inclined surface 46A of the spacer 4A. The insulating resin layer 5A is also connected to the solder H (conductive adhesive). Specifically, the insulating resin layer 5A includes a main layer 51A on the multilayer body second main surface A2 and connection portions 52A at both ends of the main layer 51A, and the connection portions 52A are each connected to the inclined surface 46A and the solder H (conductive adhesive). The connection portions 52A are upward-spread portions extending from the main layer 51A.

As described above, in the present example embodiment, the connection portion 52A of the insulating resin layer 5A is connected to the inclined surface 46A. In other words, the material of the insulating resin layer 5A can be accommodated in a space defined by the inclined surface 46A, thus making it possible to prevent or reduce excessive upward spreading of the material of the insulating resin layer 5A. That is, it is possible to prevent or reduce the occurrence of a situation in which the material of the insulating resin layer 5A moves from the multilayer body second main surface A2 toward the spacer second main surface D2 of the spacer 4A and reaches the spacer second main surface D2. Further, the inclined surface 46A can increase the adhesion area between the insulating resin layer 5A and the spacer 4A.

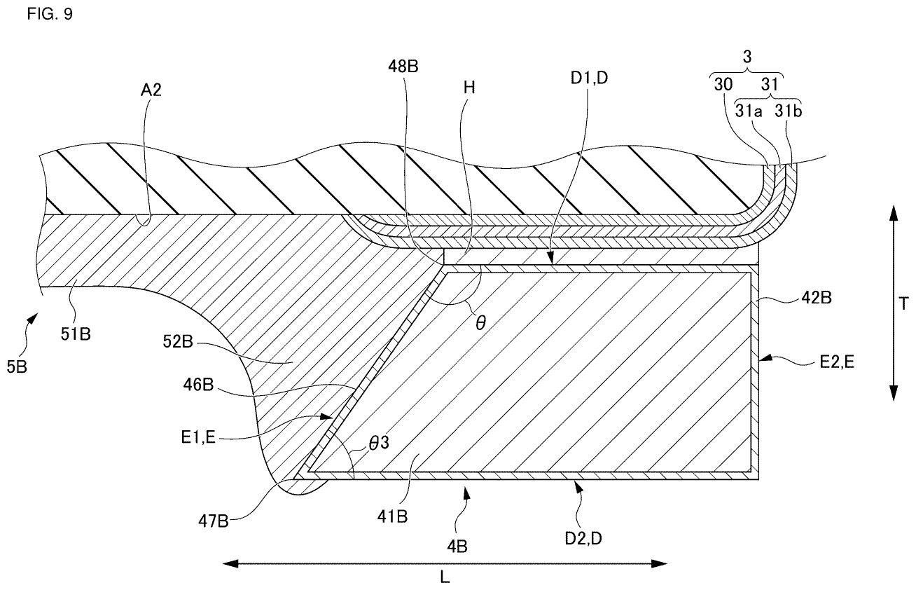

With reference to FIG. 9, an example in which the position of the inclined surface is different is described as a third example embodiment. FIG. 9 is a cross-sectional view depicting a connection state of a spacer 4B and an insulating resin layer 5B in the third example embodiment.

The spacer first end surface E1 of the spacer 4B includes an inclined surface 46B inclined with respect to the lamination direction T. The insulating resin layer 5B is connected to the inclined surface 46B (described later).

Specifically, the inclined surface 46B of the spacer first end surface E1 has a shape obtained by cutting away an original end surface of a core portion 41B as a rectangular or substantially rectangular parallelepiped, and secures a space over the entire spacer first end surface E1. That is, the inclined surface 46B extends across the entire spacer first end surface E1. The spacer second main surface D2 and the spacer first end surface E1 of the spacer 4B define a third angle θ3. Further, the spacer first main surface D1 and the spacer first end surface E1 define a fourth angle θ4. The third angle θ3 is an acute angle, and the fourth angle θ4 is an obtuse angle. That is, the third angle θ3 is smaller than the fourth angle θ4.

Specifically, a portion where the spacer second main surface D2 and the spacer first end surface E1 of the spacer 4B intersect is a first ridge portion 47B. A portion where the spacer first main surface D1 and the spacer first end surface E1 intersect is a second ridge portion 48B. The first ridge portion 47B is located on an inner side in the length direction L, that is, on a side closer to the other spacer, relative to the second ridge portion 48B. Due to this structure, a material of the insulating resin layer 5B is less likely to excessively spread upward to the spacer second main surface D2.

Further, the first ridge portion 47B is located on the inner side in the length direction L, that is, on the side closer to the other spacer, relative to the outer electrode 3. Due to this structure, the material of the insulating resin layer 5B is less likely to excessively spread upward to the spacer second main surface D2.

The insulating resin layer 5B is directly connected to the multilayer body second main surface A2 of the multilayer body 2 and the inclined surface 46B of the spacer 4B. The insulating resin layer 5B is also connected to the solder H (conductive adhesive). Specifically, the insulating resin layer 5B includes a main layer 51B on the multilayer body second main surface A2 and connection portions 52B at both ends of the main layer 51B, and the connection portions 52B are each connected to the inclined surface 46B and the solder H (conductive adhesive). The connection portions 52B are upward-spread portions extending from the main layer 51B.

As described above, in the present example embodiment, the connection portion 52B of the insulating resin layer 5B is connected to the inclined surface 46B. In other words, the material of the insulating resin layer 5B can be accommodated in a space defined by the inclined surface 46B, thus making it possible to prevent or reduce excessive upward spreading of the material of the insulating resin layer 5B. Accordingly, it is possible to reduce the amount of the material of the insulating resin layer 5B that moves from the multilayer body second main surface A2 toward the spacer second main surface D2 of the spacer 4B and reaches the spacer second main surface D2.

In the present example embodiment, the connection portion 52B extends beyond the inclined surface 46B and further toward the spacer second main surface D2, and covers the first ridge portion 47B. Specifically, the first ridge portion 47B and a portion of the spacer second main surface D2 are covered by the connection portion 52B. The portion of the spacer second main surface D2 covered by the connection portion 52B is a portion in the vicinity of the first ridge portion 47B. The first ridge portion 47B can be protected by being covered by the insulating resin layer 5B.

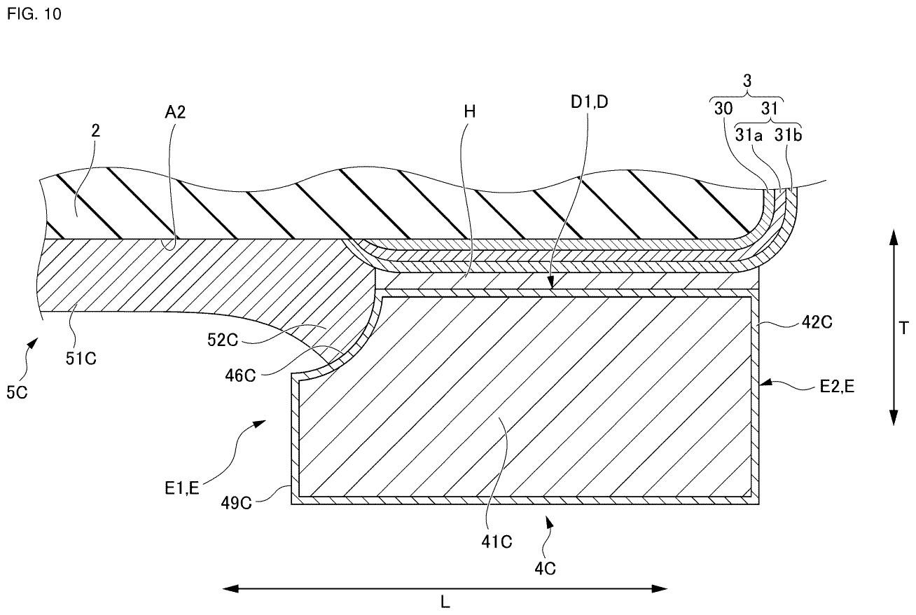

In the first example embodiment, a space into which the insulating resin layer 5 moves is defined in the spacer 4 by the inclined surface 46. However, the shape of the space is not limited to the first example embodiment. With reference to FIG. 10, an example in which the shape of the space is different is described as a fourth example embodiment. FIG. 10 is a cross-sectional view depicting a connection state of a spacer 4C and an insulating resin layer 5C in the fourth example embodiment.

The spacer first end surface E1 of the spacer 4C includes a curved concave portion 46C that is concave in the length direction L. The insulating resin layer 5C is connected to the curved concave portion 46C (described later).

Specifically, the curved concave portion 46C of the spacer first end surface E1 has a shape obtained by cutting away an original corner portion between the spacer first end surface E1 and the spacer first main surface D1 of a core portion 41C as a rectangular or substantially rectangular parallelepiped, and secures a space on the spacer first main surface D1 side of the spacer first end surface E1. That is, the curved concave portion 46C is partially provided in the spacer first end surface E1 on the spacer first main surface D1 side. The spacer first end surface E1 on the spacer second main surface D2 side is a flat surface 49C parallel to the lamination direction T.

The insulating resin layer 5C is directly connected to the multilayer body second main surface A2 of the multilayer body 2 and the curved concave portion 46C of the spacer 4C. The insulating resin layer 5C is also connected to the solder H (conductive adhesive). Specifically, the insulating resin layer 5C includes a main layer 51C on the multilayer body second main surface A2 and connection portions 52C at both ends of the main layer 51C, and the connection portions 52C are each connected to the curved concave portion 46C and the solder H (conductive adhesive). The connection portions 52C are upward-spread portions extending from the main layer 51C.

As described above, in the present example embodiment, the connection portion 52C of the insulating resin layer 5C is connected to the curved concave portion 46C. In other words, a material of the insulating resin layer 5C is accommodated in a space defined by the curved concave portion 46C, thus making it possible to prevent or reduce excessive upward spreading of the material of the insulating resin layer 5C.

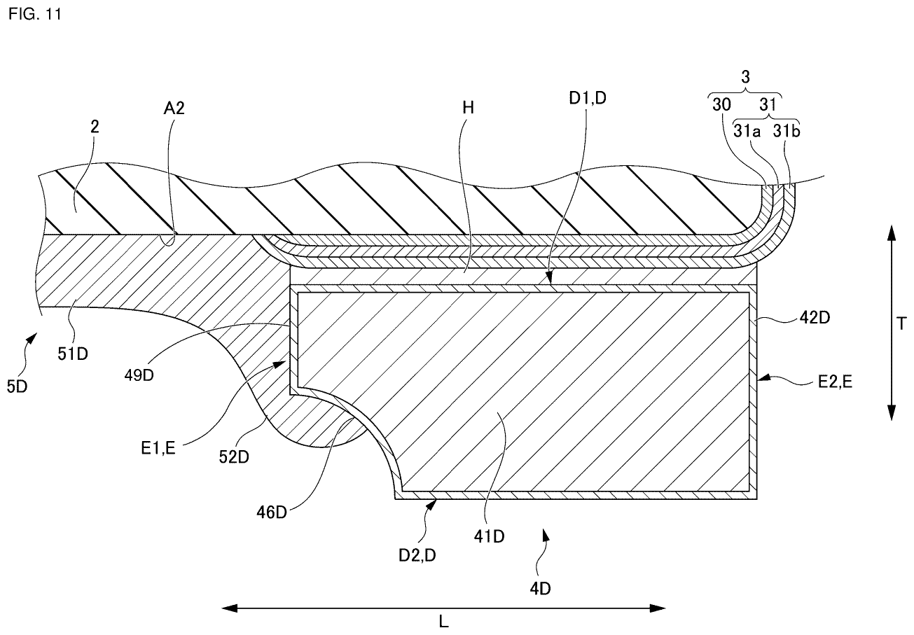

With reference to FIG. 11, an example in which the shape of the concave portion is different is described as a fifth example embodiment. FIG. 11 is a cross-sectional view depicting a connection state of a spacer 4D and an insulating resin layer 5D in the fifth example embodiment.

The spacer first end surface E1 of the spacer 4D includes a curved concave portion 46D that is concave in the length direction L. The insulating resin layer 5D is connected to the curved concave portion 46D (described later).

Specifically, the curved concave portion 46D of the spacer first end surface E1 has a shape obtained by cutting away an original corner portion between the spacer first end surface E1 and the spacer second main surface D2 of a core portion 41D as a rectangular or substantially rectangular parallelepiped, and secures a space on the spacer second main surface D2 side of the spacer first end surface E1. That is, the curved concave portion 46D is partially provided in the spacer first end surface E1 on the spacer second main surface D2 side. The spacer first end surface E1 on the spacer first main surface D1 side is a flat surface 49D parallel to the lamination direction T.

The insulating resin layer 5D is directly connected to the multilayer body second main surface A2 of the multilayer body 2 and the curved concave portion 46D of the spacer 4D. The insulating resin layer 5D is also connected to the solder H (conductive adhesive). Specifically, the insulating resin layer 5D includes a main layer 51D on the multilayer body second main surface A2 and connection portions 52D at both ends of the main layer 51D, and the connection portions 52D are each connected to the flat surface 49D, the curved concave portion 46D, and the solder H (conductive adhesive). The connection portions 52D are upward-spread portions extending from the main layer 51D.

As described above, in the present example embodiment, the connection portion 52D of the insulating resin layer 5D is connected to the curved concave portion 46D. In other words, a material of the insulating resin layer 5D is accommodated in a space defined by the curved concave portion 46D, thus making it possible to prevent or reduce excessive upward spreading of the material of the insulating resin layer 5D.

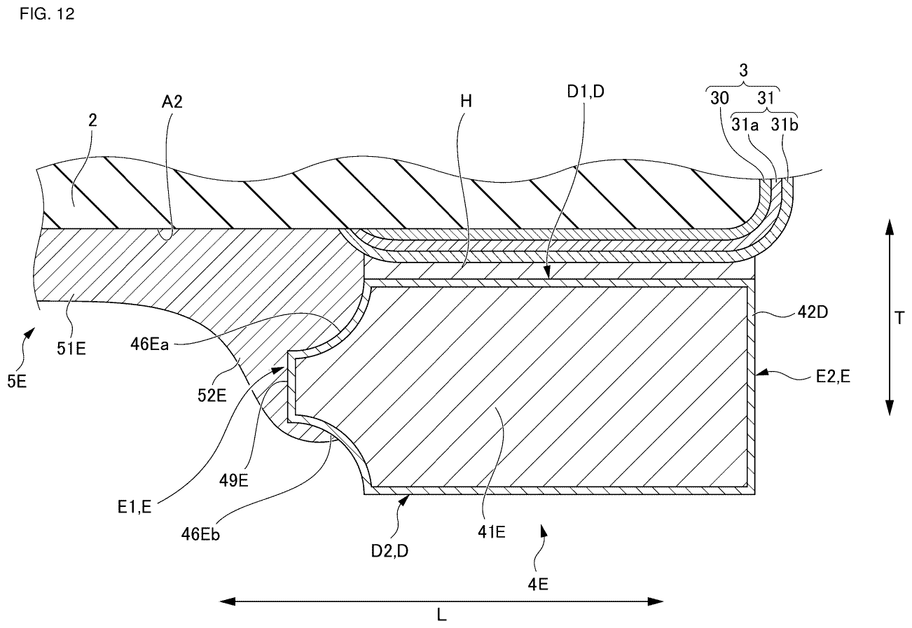

With reference to FIG. 12, an example in which the shape of the concave portion is different is described as a sixth example embodiment. FIG. 12 is a cross-sectional view depicting a connection state of a spacer 4E and an insulating resin layer 5E in the sixth example embodiment.

The spacer first end surface E1 of the spacer 4E includes a first curved concave portion 46Ea and a second curved concave portion 46Eb that are concave in the length direction L. The insulating resin layer 5E is connected to the first curved concave portion 46Ea and the second curved concave portion 46Eb (described later).

Specifically, the first curved concave portion 46Ea of the spacer first end surface E1 has a shape obtained by cutting away an original corner portion between the spacer first end surface E1 and the spacer first main surface D1 of a core portion 41E as a rectangular or substantially rectangular parallelepiped, and secures a space on the spacer first main surface D1 side of the spacer first end surface E1. That is, the first curved concave portion 46Ea is partially provided in the spacer first end surface E1 on the spacer first main surface D1 side. The second curved concave portion 46Eb of the spacer first end surface E1 has a shape obtained by cutting away an original corner portion between the spacer first end surface E1 and the spacer second main surface D2 of the core portion 41E as the rectangular parallelepiped, and secures a space on the spacer second main surface D2 side of the spacer first end surface E1. That is, the second curved concave portion 46Eb is partially provided in the spacer first end surface E1 on the spacer second main surface D2 side. A surface between the first curved concave portion 46Ea and the second curved concave portion 46Eb is a flat surface 49E parallel to the lamination direction T.

The insulating resin layer 5E is directly connected to the multilayer body second main surface A2 of the multilayer body 2 and the first curved concave portion 46Ea and the second curved concave portion 46Eb of the spacer 4E. The insulating resin layer 5E is also connected to the solder H (conductive adhesive). Specifically, the insulating resin layer 5E includes a main layer 51E on the multilayer body second main surface A2 and connection portions 52E at both ends of the main layer 51E, and the connection portions 52E are each connected to the flat surface 49E, the first curved concave portion 46Ea, the second curved concave portion 46Eb, and the solder H (conductive adhesive). The connection portions 52E are upward-spread portions extending from the main layer 51E.

As described above, in the present example embodiment, the connection portion 52E of the insulating resin layer 5E is connected to the first curved concave portion 46Ea and the second curved concave portion 46Eb. In other words, a material of the insulating resin layer 5E is accommodated in a space defined by the first curved concave portion 46Ea and the second curved concave portion 46Eb, thus making it possible to prevent or reduce excessive upward spreading of the material of the insulating resin layer 5E. That is, it is possible to prevent or reduce the occurrence of a situation in which the material of the insulating resin layer 5E moves from the multilayer body second main surface A2 toward the spacer second main surface D2 of the spacer 4E and reaches the spacer second main surface D2.

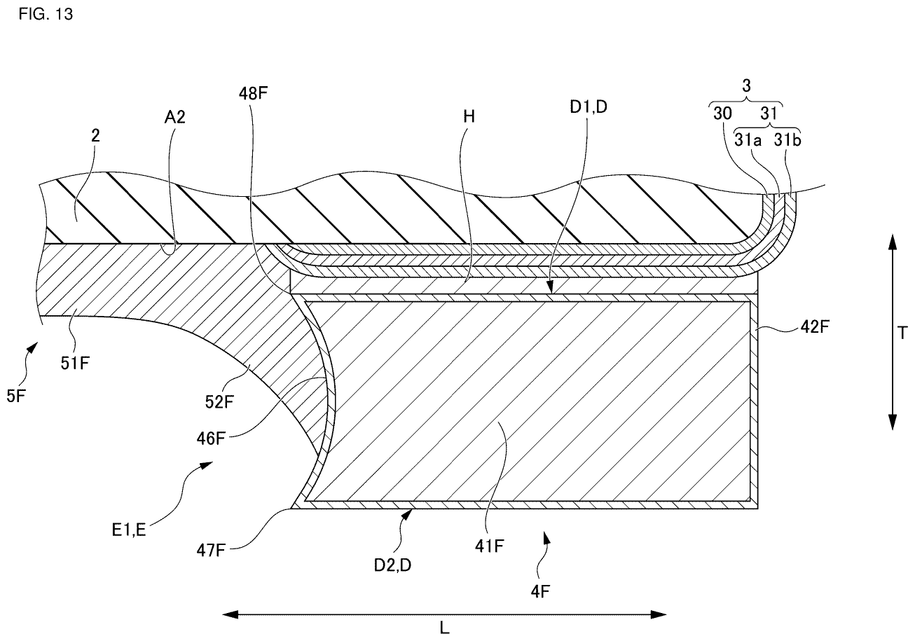

With reference to FIG. 13, an example in which the shape of the concave portion is different is described as a seventh example embodiment. FIG. 13 is a cross-sectional view depicting a connection state of a spacer 4F and an insulating resin layer 5F in the seventh example embodiment.

The spacer first end surface E1 of the spacer 4F has a curved concave portion 46F that is concave in the length direction L. The insulating resin layer 5F is connected to the curved concave portion 46F (described later).

Specifically, the curved concave portion 46F of the spacer first end surface E1 has a shape obtained by cutting away an original end surface of a core portion 41F as a rectangular or substantially rectangular parallelepiped, and secures a space over the entire spacer first end surface E1. That is, the curved concave portion 46F extends across the entire spacer first end surface E1.

Specifically, a portion where the spacer second main surface D2 and the spacer first end surface E1 of the spacer 4F intersect is a first ridge portion 47F. A portion where the spacer first main surface D1 and the spacer first end surface E1 intersect is a second ridge portion 48F. The positions of the first ridge portion 47F and the second ridge portion 48F in the length direction L are the same.

The insulating resin layer 5F is directly connected to the multilayer body second main surface A2 of the multilayer body 2 and the curved concave portion 46F of the spacer 4F. The insulating resin layer 5F is also connected to the solder H (conductive adhesive). Specifically, the insulating resin layer 5F includes a main layer 51F on the multilayer body second main surface A2 and connection portions 52F at both ends of the main layer 51F, and the connection portions 52F are each connected to the curved concave portion 46F and the solder H (conductive adhesive). The connection portions 52F are upward-spread portions extending from the main layer 51F.

As described above, in the present example embodiment, the connection portion 52F of the insulating resin layer 5F is connected to the curved concave portion 46F. In other words, a material of the insulating resin layer 5F is accommodated in a space defined by the curved concave portion 46F, thus making it possible to prevent or reduce excessive upward spreading of the material of the insulating resin layer 5F.

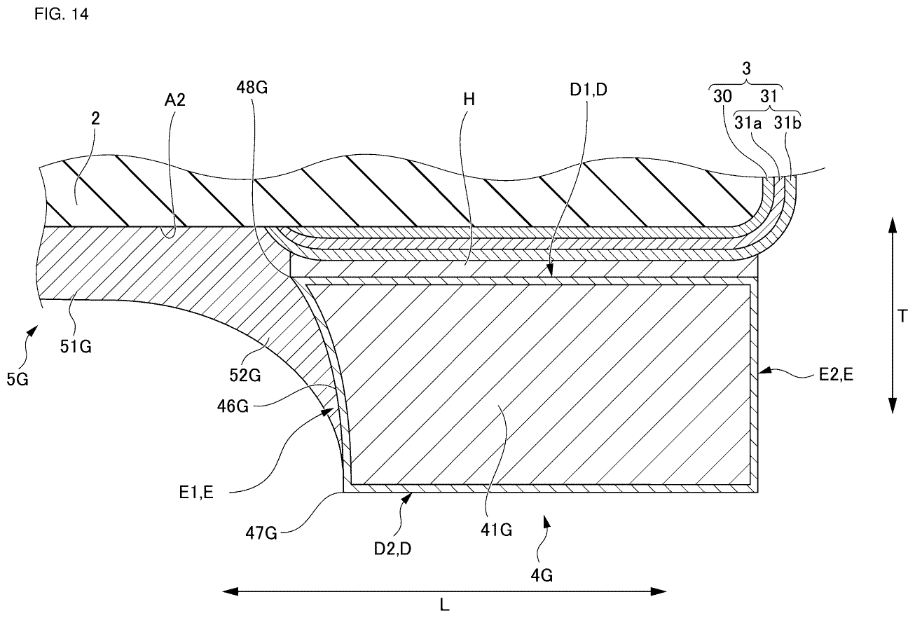

With reference to FIG. 14, an example in which the shape of the concave portion is different is described as an eighth example embodiment. FIG. 14 is a cross-sectional view depicting a connection state of a spacer 4G and an insulating resin layer 5G in the eighth example embodiment.

The spacer first end surface E1 of the spacer 4G has a curved concave portion 46G that is concave in the length direction L. The insulating resin layer 5G is connected to the curved concave portion 46G (described later).

Specifically, the curved concave portion 46G of the spacer first end surface E1 has a shape obtained by cutting away an original end surface of a core portion 41G as a rectangular or substantially rectangular parallelepiped, and secures a space over the entire spacer first end surface E1. That is, the curved concave portion 46G extends across the entire spacer first end surface E1.

Specifically, a portion where the spacer second main surface D2 and the spacer first end surface E1 of the spacer 4G intersect is a first ridge portion 47G. A portion where the spacer first main surface D1 and the spacer first end surface E1 intersect is a second ridge portion 48G. The first ridge portion 47G is located on an outer side in the length direction L, that is, on a side farer to the other spacer, relative to the second ridge portion 48G. Due to this structure, a material of the insulating resin layer 5G is less likely to spread upward.

The insulating resin layer 5G is directly connected to the multilayer body second main surface A2 of the multilayer body 2 and the curved concave portion 46G of the spacer 4G. The insulating resin layer 5G is also connected to the solder H (conductive adhesive). Specifically, the insulating resin layer 5G includes a main layer 51G on the multilayer body second main surface A2 and connection portions 52G at both ends of the main layer 51G, and the connection portions 52G are each connected to the curved concave portion 46G and the solder H (conductive adhesive). The connection portions 52G are upward-spread portions extending from the main layer 51G.

As described above, in the present example embodiment, the connection portion 52G of the insulating resin layer 5G is connected to the curved concave portion 46G. In other words, the material of the insulating resin layer 5G is accommodated in a space defined by the curved concave portion 46G, thus making it possible to prevent or reduce excessive upward spreading of the material of the insulating resin layer 5G.

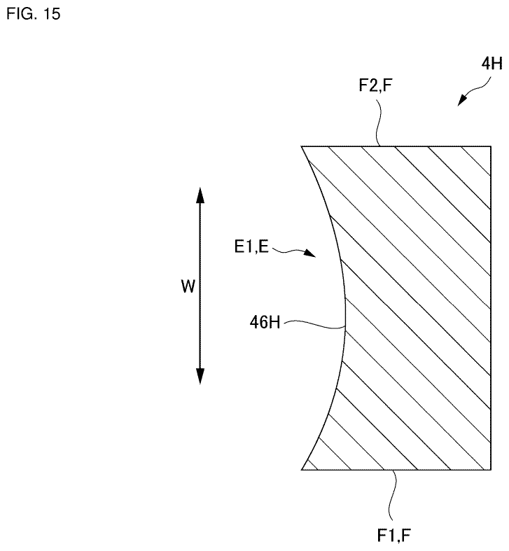

The shape of the curved concave portion included in the spacer first end surface of the spacer may be a shape curved in plan view. With reference to FIG. 15, an example of the curved concave portion curved in plan view is described as a ninth example embodiment. FIG. 15 is a schematic transverse cross-sectional view of a spacer 4H in the ninth example embodiment. In the ninth to twelfth example embodiments described below, a simple description is given using only the schematic shape of the spacer 4.

A curved concave portion 46H is included in the spacer first end surface E1 of the spacer 4H. The curved concave portion 46H is concave toward the spacer second end surface E2. The curved concave portion 46H extends across the entire spacer first end surface E1, that is, from the spacer first side surface F1 to the spacer second side surface F2.

In the present example embodiment, a material of the insulating resin layer can be accommodated in a space defined by the curved concave portion 46H, thus making it possible to prevent or reduce excessive upward spreading of the material of the insulating resin layer.

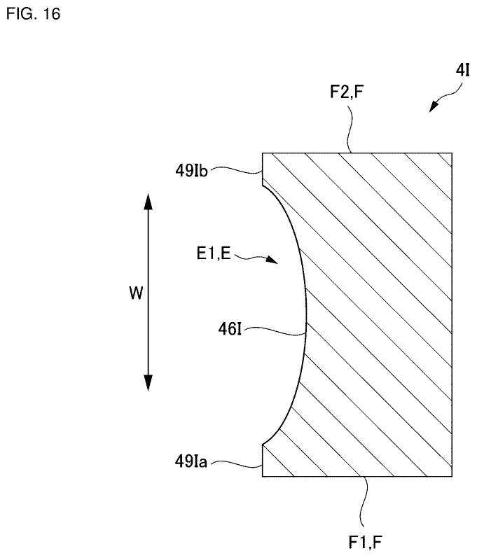

With reference to FIG. 16, an example of the curved concave portion curved in plan view is described as the tenth example embodiment. FIG. 16 is a schematic transverse cross-sectional view of a spacer 4I in the tenth example embodiment.

A curved concave portion 46I is included in the spacer first end surface E1 of the spacer 4I. The curved concave portion 46I is concave toward the spacer second end surface E2. The curved concave portion 46I extends across substantially the entire spacer first end surface E1, that is, from the spacer first side surface F1 to the spacer second side surface F2. A pair of flat surfaces 49Ia and 49Ib are formed at both ends of the curved concave portion 46I in the width direction W.

In the present example embodiment, a material of the insulating resin layer can be accommodated in a space defined by the curved concave portion 46I, thus making it possible to prevent or reduce excessive upward spreading of the material of the insulating resin layer.

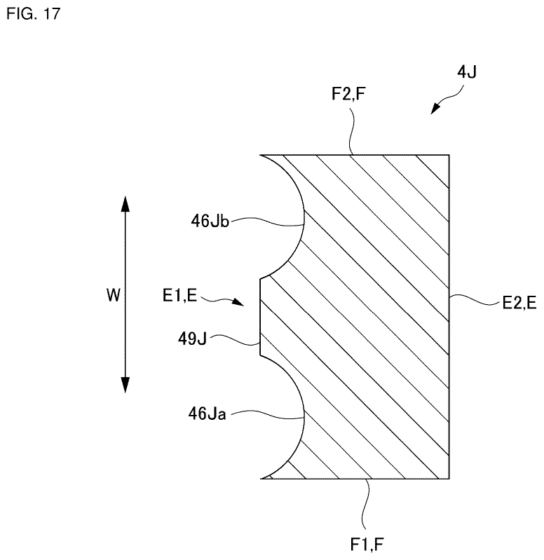

With reference to FIG. 17, an example of the curved concave portion curved in plan view is described as the eleventh example embodiment. FIG. 17 is a schematic transverse cross-sectional view of a spacer 4J in the eleventh example embodiment.

A curved concave portion 46Ja and a curved concave portion 46Jb are included in the spacer first end surface E1 of the spacer 4J. The curved concave portion 46Ja and the curved concave portion 46Jb are concave toward the spacer second end surface E2. A flat surface 49J is provided between the curved concave portion 46Ja and the curved concave portion 46Jb.

In the present example embodiment, a material of the insulating resin layer can be accommodated in a space defined by the curved concave portion 46Ja and the curved concave portion 46Jb, thus making it possible to prevent or reduce excessive upward spreading of the material of the insulating resin layer.

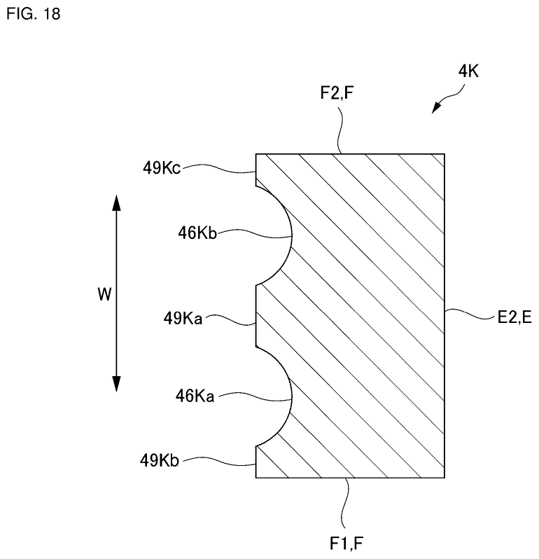

With reference to FIG. 18, an example of the curved concave portion curved in plan view is described as the twelfth example embodiment. FIG. 18 is a schematic transverse cross-sectional view of a spacer 4K in the twelfth example embodiment.

A curved concave portion 46Ka and a curved concave portion 46Kb are included in the spacer first end surface E1 of the spacer 4K. A flat surface 49Ka is provided between the curved concave portion 46Ka and the curved concave portion 46Kb. The curved concave portion 46Ka and the curved concave portion 46Kb are concave toward the spacer second end surface E2. A flat surface 49Kb is provided between the curved concave portion 46Ka and the spacer first side surface F1, and a flat surface 49Kc is provided between the curved concave portion 46Kb and the spacer second side surface F2.

A material of the insulating resin layer can be accommodated in a space defined by the curved concave portion 46Ka and the curved concave portion 46Kb, thus making it possible to prevent or reduce excessive upward spreading of the material of the insulating resin layer.

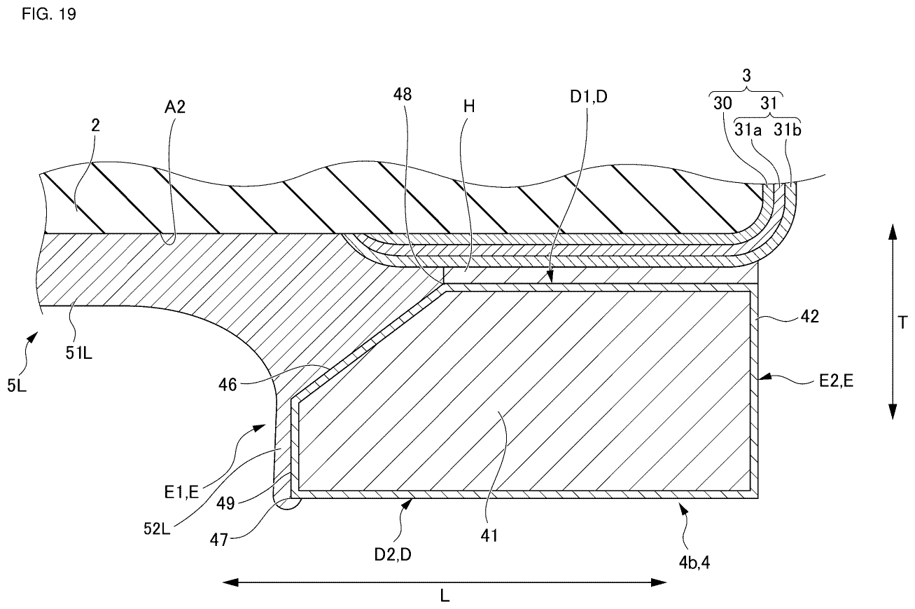

A modification of the first example embodiment is described with reference to FIG. 19. FIG. 19 is a cross-sectional view depicting a connection state of a spacer and an insulating resin layer in the modification of the first example embodiment. In this modification, the upward spreading position of a material of an insulating resin layer 5L is different.

The insulating resin layer 5L is directly connected to the multilayer body second main surface A2 of the multilayer body 2 and the inclined surface 46 of the spacer 4. The insulating resin layer 5L is also connected to the solder H (conductive adhesive). Specifically, the insulating resin layer 5L includes a main layer 51L on the multilayer body second main surface A2 and connection portions 52L at both ends of the main layer 51L, and the connection portions 52L are each connected to the inclined surface 46 and the solder H (conductive adhesive). The connection portions 52L are upward-spread portions extending from the main layer 51L.

In the present modification, the connection portion 52L extends beyond the flat surface 49 and further toward the spacer second main surface D2, and covers the first ridge portion 47. Specifically, the first ridge portion 47 and portion of the spacer second main surface D2 are covered by the connection portion 52L. The portion of the spacer second main surface D2 covered by the connection portion 52L is a portion in the vicinity of the first ridge portion 47. The first ridge portion 47 can be protected by being covered by the insulating resin layer 5L.

Although the plurality of example embodiments of the present invention have been described above, the present invention is not limited to the above example embodiments, and various modifications can be made without departing from the gist of the invention. In particular, the example embodiments and the modifications described in the present specification can be combined in any manner as required.

The inclined surface or the curved concave portion may be provided with irregularities. It is preferable that the surface roughness of the inclined surface and the curved concave portion be rougher than the surface roughness of the core portion in the other portion.

The inclined surface and the curved concave portion may be coated with the solder H (conductive adhesive) used to connect the outer electrode and the spacer, and the insulating resin layer may be disposed thereon.

The core portion and the insulating resin layer may be directly connected on the inclined surface and the curved concave portion. A high-melting-point surface layer having a higher melting point than the low-melting-point surface layer may be provided on the inclined surface and the curved concave portion, and the high-melting-point surface layer and the insulating resin layer may be directly connected. This can reduce or prevent a decrease in the adhesion force between the spacer and the insulating resin layer caused by melting of the low-melting-point surface layer during reflow of the solder H (conductive adhesive).

The low-melting-point surface layer and the high-melting-point surface layer are not required to be provided over the flat surface.

The outer electrode may include a combination of Ni with an additive material and Cu/Ni/Sn plating.

The outer electrode may include a combination of Ni with an additive material, Cu with a glass component, and Ni/Sn plating.

The outer electrode may include a combination of Cu with a glass component, a resin electrode, and Ni/Sn plating.

The shape of the spacer is not particularly limited, and the spacer may have a shape in which an outer side portion in the first direction is cut away. This makes it possible to prevent or reduce excessive upward spreading of solder to the multilayer ceramic capacitor. Similarly to the spacer first end surfaces E1 in the ninth to twelfth example embodiments, the spacer second end surface E2 may also have a similar shape.

Further, a concave portion may extend from the spacer second main surface D2 toward the spacer first main surface D1. It is preferable that the low-melting-point surface layer be disposed on a circumferential surface of the concave portion included in the spacer. This can reduce or prevent excessive solder upward spreading, to the capacitor body 1A, of the solder H used in mounting. At this time, the insulating resin layer may extend around so as to cover portion of the concave portion or the concave portion. In this case, because a cavity is included in the spacer, vibration can be damped by the cavity portion.

Further, a concave portion may extend from the spacer first main surface D1 toward the spacer second main surface D2. It is preferable that the low-melting-point surface layer be disposed on a circumferential surface of the concave portion included in the spacer. This can reduce or prevent excessive solder upward spreading, to the capacitor body 1A, of the solder H used in connecting the spacer and the capacitor body.

Further, the spacer may include a hole extending from the spacer first main surface D1 to the spacer second main surface D2. It is preferable that the low-melting-point surface layer be disposed on a circumferential surface of the hole included in the spacer. This can reduce or prevent excessive solder upward spreading, to the capacitor body 1A, of the solder H used in mounting or in connecting the spacer and the capacitor body. At this time, the insulating resin layer may extend around so as to cover portion of the hole portion or the hole portion. A gap may be present between the solder H entering the hole from the spacer first main surface D1 and the insulating resin layer extending around from the spacer second main surface D2. In this case, because a cavity is included in the spacer, vibration can be damped by the cavity portion.

The shape of the insulating resin layer 5 in plan view is not limited to a rectangular or substantially rectangular shape. The edges of the insulating resin layer extending in the length direction L may be linear. Alternatively, the edges may have a curved shape convex outward in the width direction W, or have a curved shape concave inward in the width direction W.

The size of the spacer 4 in a view along the lamination direction T is not particularly limited. The spacer 4 may be smaller than the area of the outer electrode 3 connected through solder, and may be separated from an end portion of the outer electrode 3 on the outer side in the length direction L. This can prevent excessive upward spreading of the solder to the capacitor body 1A.

Further, when the outer electrode 3 is bisected in the length direction L, the spacer 4 may be located near the outer electrode 3 on the inner side in the length direction L. This can prevent excessive upward spreading of the solder to the capacitor body 1A.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor body including a multilayer body including a main surface and a pair of outer electrodes separated from each other in a first direction;
a pair of spacers each connected to a respective one of the pair of outer electrodes; and
a coating material on the main surface; wherein
each of the pair of spacers includes an inner surface on a side where the pair of spacers are opposed to each other in the first direction;
the coating material is connected to the main surface of the multilayer body and the inner surface of the spacer;
the inner surface includes an inclined surface that is inclined with respect to a height direction in which the capacitor body and the spacer are arranged; and
the coating material is connected to the inclined surface.

2. The multilayer ceramic electronic component according to claim 1, further comprising:
a conductive adhesive that connects each of the pair of outer electrodes to a respective one of the pair of spacers.

3. The multilayer ceramic electronic component according to claim 2, wherein the coating material is connected to the main surface of the multilayer body, the conductive adhesive, and the inclined surface.

4. The multilayer ceramic electronic component according to claim 1, wherein
each of the pair of spacers includes a first main surface and a second main surface facing each other in the height direction in which the capacitor body and the spacer are arranged;
the first main surface is located on the capacitor body side; and
a ridge portion where the second main surface and the inner surface intersect is located on an inner side in the first direction relative to a ridge portion where the first main surface and the inner surface intersect.

5. The multilayer ceramic electronic component according to claim 4, wherein the ridge portion where the second main surface and the inner surface intersect is located on the inner side in the first direction relative to the outer electrode.

6. The multilayer ceramic electronic component according to claim 1, wherein
each of the pair of spacers includes a first main surface and a second main surface facing each other in the height direction in which the capacitor body and the spacer are arranged;
the first main surface is located on the capacitor body side; and
an angle between the second main surface and the inner surface is more acute than an angle between the first main surface and the inner surface.

7. The multilayer ceramic electronic component according to claim 6, wherein a ridge portion where the second main surface and the inner surface intersect is located on an inner side in the first direction relative to the outer electrode.

8. The multilayer ceramic electronic component according to claim 6, wherein the coating material covers a ridge portion where the second main surface and the inner surface intersect.

9. The multilayer ceramic electronic component according to claim 1, wherein the coating material is an insulating resin layer.

10. The multilayer ceramic electronic component according to claim 1, wherein the coating material is directly connected to the main surface of the multilayer body and the inclined surface of the spacer.

11. A multilayer ceramic electronic component comprising:
a capacitor body including a multilayer body including a main surface and a pair of outer electrodes separated from each other in a first direction;
a pair of spacers each connected to a respective one of the pair of outer electrodes; and
a coating material on the main surface; wherein each of the pair of spacers includes an inner surface on a side where the pair of spacers are opposed to each other;
the coating material is connected to the main surface of the multilayer body and the inner surface;
the inner surface includes a curved concave portion; and
the coating material is connected to the curved concave portion.

12. The multilayer ceramic electronic component according to claim 11, further comprising:
a conductive adhesive that connects the pair of outer electrodes to the pair of spacers.

13. The multilayer ceramic electronic component according to claim 12, wherein the coating material is connected to the main surface of the multilayer body, the conductive adhesive, and the curved concave portion.

14. The multilayer ceramic electronic component according to claim 11, wherein
each of the pair of spacers includes a first main surface and a second main surface facing each other in the height direction in which the capacitor body and the spacer are arranged;
the first main surface is located on the capacitor body side; and
a ridge portion where the second main surface and the inner surface intersect is located on an inner side in the first direction relative to a ridge portion where the first main surface and the inner surface intersect.

15. The multilayer ceramic electronic component according to claim 14, wherein the ridge portion where the second main surface and the inner surface intersect is located on the inner side in the first direction relative to the outer electrode.

16. The multilayer ceramic electronic component according to claim 11, wherein
each of the pair of spacers includes a first main surface and a second main surface facing each other in the height direction in which the capacitor body and the spacer are arranged;
the first main surface is located on the capacitor body side; and
an angle between the second main surface and the inner surface is more acute than an angle between the first main surface and the inner surface.

17. The multilayer ceramic electronic component according to claim 16, wherein a ridge portion where the second main surface and the inner surface intersect is located on an inner side in the first direction relative to the outer electrode.

18. The multilayer ceramic electronic component according to claim 16, wherein the coating material covers a ridge portion where the second main surface and the inner surface intersect.

19. The multilayer ceramic electronic component according to claim 11, wherein the coating material is an insulating resin layer.

20. The multilayer ceramic electronic component according to claim 11, wherein the coating material is directly connected to the main surface of the multilayer body and the inclined surface of the spacer.
